(19) United States
(12) Patent Application Publication
(10) Pub. No.: US 2003/0149827 A1
(43) Pub. Date: Aug. 7, 2003

(54) Multi-drop bus to personal computer interface

(76) Inventors: Chris Smolen, Oneida, NY (US); Glenn Schnauber, Rochester, NY (US)

Correspondence Address: DAVID GIGLIO, ESQ, 231 Elizabeth Street, Utica, NY, 13501, US

(21) Appl. No.: 10/060,813

(22) Filed: Feb. 1, 2002

(51) Int. Cl. G06F 13/36

(52) U.S. Cl. 710/315

(57) ABSTRACT

In a vending system there is at least one vending device which transmits data across a multidrop bus to a personal computer. The vending system data includes a start bit, a plurality of data bits, a modal bit and a stop bit. A multidrop bus to personal computer interface polls each vending device and manages and removes the modal bit, thereby freeing up the personal computer for application oriented functions.

### FIELD OF THE INVENTION

This invention relates to the field of digital computer Interfaces, and more particularly to a mechanism for interfacing vending industry standard Multi-drop Bus (Multidrop bus) communication protocol to digital computer serial interfaces.

### BACKGROUND OF THE INVENTION

As industry moves toward personal computer based controllers for vending applications, it has become necessary to provide a mechanism for personal computer to Multidrop bus interface. Until now, it has not been possible to interface standard vending equipment using the Multidrop bus to the personal computer.

The vending industry standard Multidrop bus protocol is incompatible with personal computer interface protocol. This includes the RS-232, RS-232C, RS-485, and Universal Serial Bus (USB) protocols. The vending industry standard Multidrop bus protocol is designed to be used with a vending machine controller (VMC). This VMC controls vending devices using a higher voltage (typically 24-48 VDC) and has unusual data framing and control bits with stringent polling requirements.

It is quite tedious to have the same computer controller perform the data polling as well as the vending applications. The personal computer controller is so consumed with polling that the vending applications run too slow to be useful to the end user.

### OBJECTS AND SUMMARY OF INVENTION

It is therefore an object of the present invention to improve the art of the vending industry.

It is a further object of the present invention to provide a system an apparatus that links vending industry standard protocol to a personal computer controller.

It is also an object of the present invention to provide a system and apparatus that converts the data framing and the voltage levels into a Personal computer serial interface readable format and performs the stringent polling requirements.

It is yet another object of the present invention to connect various Multidrop bus vending machine devices for communication, such as bill validators, coin mechanisms, smart card readers and foreign currency acceptors to the personal computer.

It is still another object of the present invention to provide a method of meeting the strict polling requirements of the Multidrop bus protocol, which are less than 200 milliseconds per Multidrop bus device.

It is yet a further object of the present invention to convert the specific data framing requirements of each protocol so that duplex communication is possible.

These and other objects are provided in accordance with the present invention in which there is provided a method of interfacing the Multi-drop Bus device to a Personal computer using serial interfaces. The multi-drop bus to Personal computer interface is a serial hardware and firmware implementation for connecting multi-drop bus (Multidrop bus) compliant devices to a personal computer through any of its serial port interface protocols. The Multidrop bus is a vending machine protocol used by various devices including: pliant currency acceptors (bill validators), coin acceptors, coin dispensers, magnetic swipe cards, smart card readers, displays etc. The multi-drop bus to Personal computer interface interfaces any Multidrop bus device. Support includes the Universal Serial Bus. The Multidrop bus to Personal computer interface provides a method of performing necessary voltage conversions of the data signal to a standard RS-232/RS232C serial input.

Using the multi-drop bus to Personal computer interface to perform the polling independent of the Personal computer allows the Personal computer to perform normal operating and to respond to activity in the multi-drop bus other than polling. The multidrop bus to Personal computer interface also sends data to any Multidrop bus device. Thereby enabling two-way or full duplex communication.

Finally, it is still a further object of the present invention to incorporate the multidrop bus to Personal computer interface conversion within the physical housing of individual vending devices such as bill validators, coin mechanics, Smart Card readers, displays, et cetera. to make them an integral part of said networking device.

### DESCRIPTION OF THE DRAWINGS

The above and other objects of the present invention will be better understood by reading the following detailed description of the preferred embodiments of the invention, when considered in connection with the accompanying drawings, in which:

FIG. 1 shows a diagram of a vending system in accordance with a preferred embodiment of the present invention;

FIG. 2 shows a data gram of typical data bytes of the vending industry standard; and

FIG. 3 is a block diagram of data polling and transmission in accordance with a preferred embodiment of the present invention.

### PREFERRED EMBODIMENT

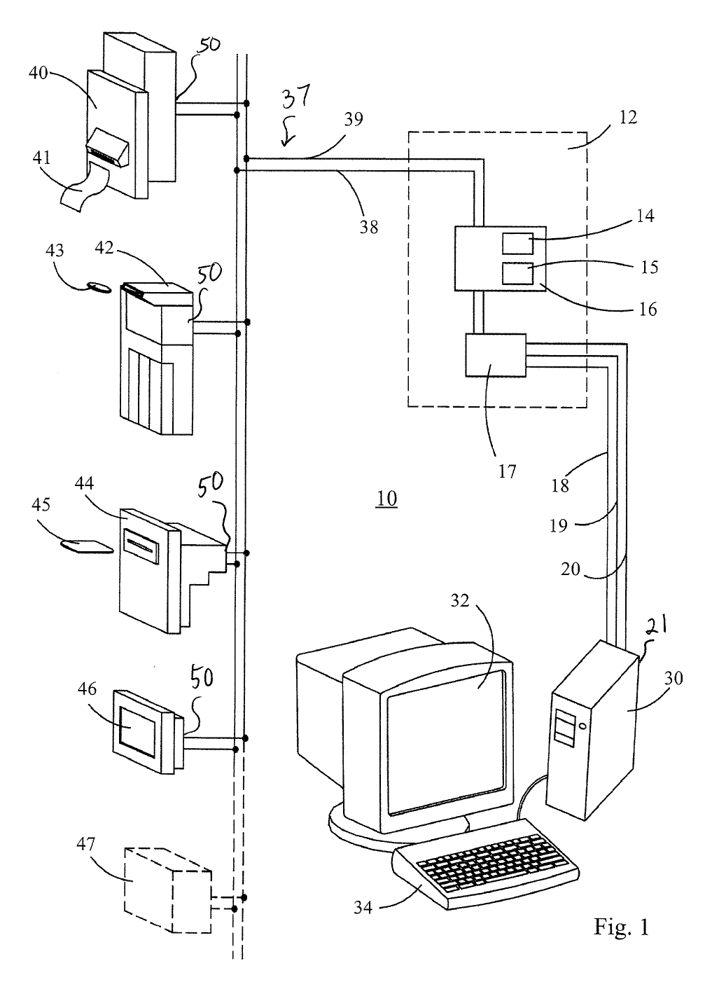

Referring now to FIG. 1, there is shown a personal computer enabled vending system 10 which includes a multi-drop bus to personal computer interface circuit 12, an industry standard multi-drop bus 38 and various vending devices 40,42,44,46,47, which may be connected to the multi-drop bus 3 8. A Multidrop bus compliant vending device may be a device such as a pliant currency acceptor 40, a coin mechanism 42, a smartcard reader 44, an output display 46, or a future device 47. The multi-drop bus to Personal computer interface 12 includes a multi drop bus to personal computer interface 16 and an RS-232, RS-232C, RS-485 or USB serial interface 17 that is connected to a serial input port 21 of a standard personal computer 30.

The multi-drop bus to personal computer interface 16 indirectly links receive 38 and transmit 39 lines of the multidrop bus 37 to the personal computer 30. The multidrop bus to personal computer interface 16 includes an embedded microprocessor 15 that has firmware 14 which performs standard data polling. The polling requirements for the various vending devices are stringent (20-200 ms). A non-dedicated personal computer cannot meet these polling requirements.

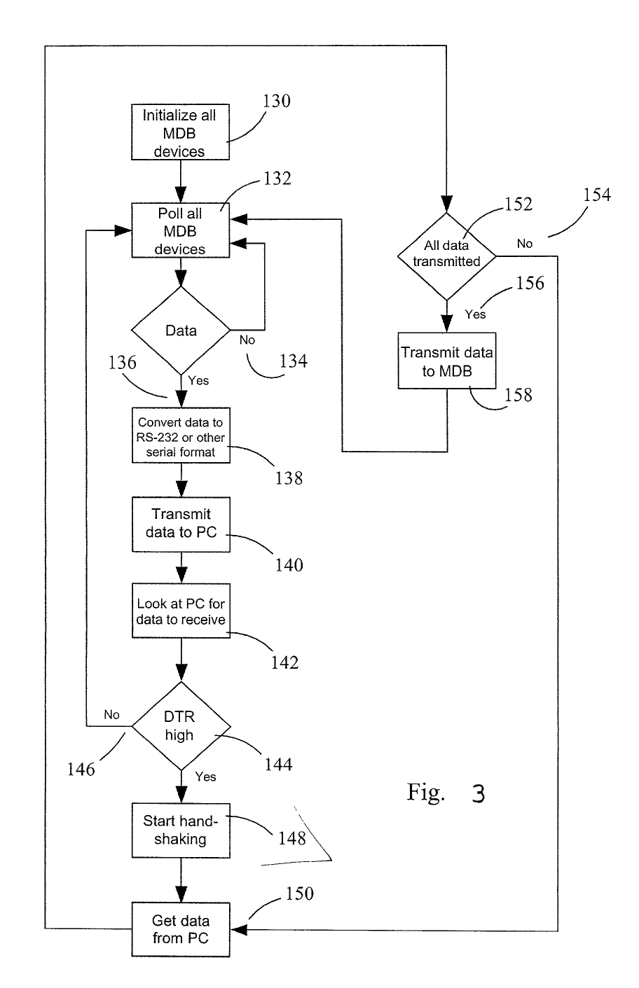

If it is determined that data from a vending device has been transmitted through the multidrop bus 37, then the firmware 14 embedded in the microprocessor 15 transposes a nine bit signal 104, shown in FIG. 3, into an eight bit signal 128 for transmission to an RS-232 or other serial interface 17. The multidrop bus interface 16 performs the polling requirements and generates an interrupt on the serial port 21 of the personal computer 30 when it is determined that vending data has been transmitted.

This method allows the personal computer 30 to perform normal operations and respond to interrupt driven communication port events. Additionally, all useful data from a vending device is available to the personal computer 30. The multi-drop bus to personal computer interface 16 also performs the required error checking by calculating checksums for all data sent and received.

The multi drop bus to personal computer interface 16 converts the voltages for transmission to the RS-232 or other serial interface 17, which then transmits useful data to the serial input 21 of the personal computer.

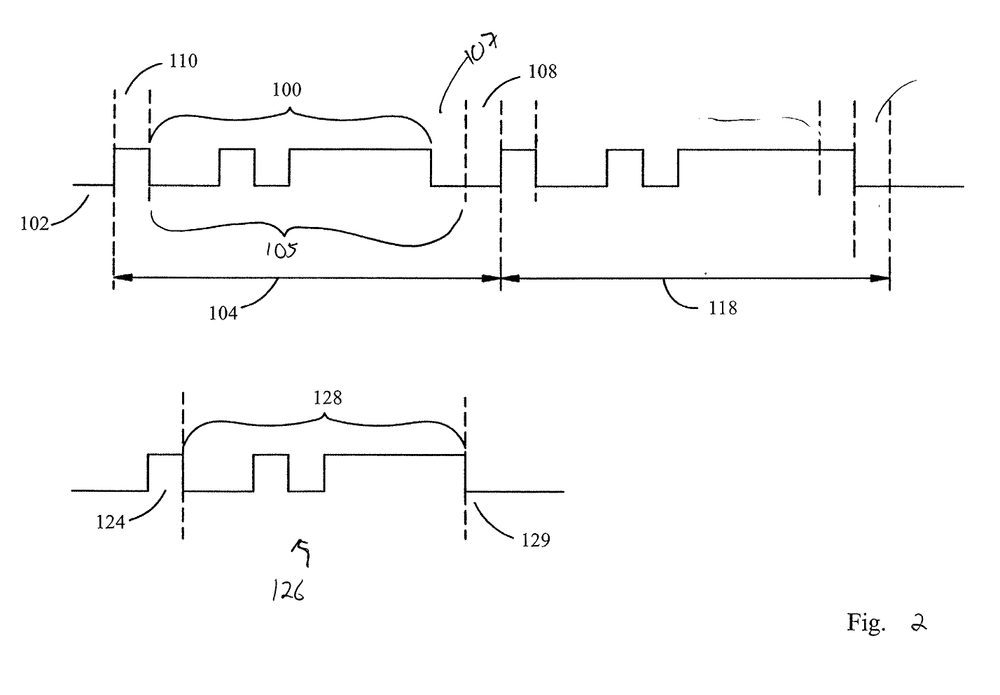

Referring now to FIG. 2, there is shown a specific data framing protocol conversion using a start bit 110, eight data bits 100, a mode bit 107 and a stop bit 108. The RS-232 protocol 126 uses a start bit 124, eight data bits 128 and a stop bit 129. These protocols are incompatible. The present invention, therefore, converts the standard vending industry multi drop bus protocol 104 to RS-232/232C protocol 128 by the following method.

As mentioned previously, the standard vending industry multidrop bus protocol uses a nine bit data and mode byte 105 rather then a standard eight bit byte 128. The multi-drop bus interface 16 converts the data from the multidrop bus to an eight bit byte by managing the mode bit 107 in the microprocessor's 15 embedded instructions. The mode bit 107 is present in all bytes of data on the multi-drop bus 37. The mode bit 107 determines the address byte for all data sent from the vending machine controller 50, the multi-drop bus interface, and ‘marks’ the last byte transmitted by all devices. Managing this ninth bit is not possible with a personal computer. The multi-drop bus interface firmware 14 manages the mode bit 107 when transmitting to all devices by setting the mode bit 107 for the address byte and clearing the mode bit 107 for all data bytes. When receiving data from a device, the multi-drop bus interface 16 tests each byte 104 to determine whether or not the mode bit 107 is set or clear. If the mode bit 107 is set, this indicates the last byte transmitted and the microprocessor's 15 embedded instructions go on to the next routine.

Each currency acceptor device must be polled at least every 200 ms. A non-dedicated personal computer 30 cannot meet this requirement without a large majority of its resources being used which would leave little left over to use the personal computer 30 for its intended task(s). By leaving these polling requirements to the firmware 14 on the multi-drop bus to personal computer interface 16, the personal computer 30 is left free to run any applications or ‘front-end’ software. Each vending device is polled by the microprocessor 15 at its own address while the microprocessor 15 waits for a response from that device. The vending device sends back either any data it has, such as credit for a coin inserted, or simply responds with an acknowledge (ACK) indicating there is not data to send but the vending device is present.

At this point the multi-drop bus interface 16 will calculate the checksum, the sum of all bytes sent in the stream of data, and compare it with the last byte transmitted from the device, which is the checksum calculated by the device itself. If the checksum matches, the multi-drop bus interface 16 will respond with an ACK to acknowledge the transmission. If the checksums do not match then the multi-drop bus to personal computer interface 16 will send a RET, telling the device to retransmit the last set of data. When the checksums are found to be correct, the microprocessor sends data through the RS-232 or other serial interface 17 to the personal computer 30 so that user application software can monitor the multidrop bus activity. The multi-drop bus to personal computer interface firmware 14 then polls the next device. This continues until all devices have been polled and all data has been confirmed.

The multi-drop bus to personal computer interface 16 also needs to look at the personal computer 30 for any information that it may have to send through to a vending device. This is done after all devices have been polled. The multi-drop bus to personal computer interface 16 tests DTR on the personal computer 30 serial port 21. If DTR is set low, the microprocessor continues polling the vending devices. After all of the vending devices have been polled, DTR is tested again. This cycle continues until DTR is seen as being set high. If DTR is set high, the microprocessor toggles CTS telling the front-end software to transmit any data it needs to send. The multi-drop bus to personal computer interface 16 receives and stores this data until all data has been sent by the personal computer 30. The personal computer indicates that all data has been sent by setting DTR low. Typically any data that is sent from the personal computer are vending machine controller commands. These commands can ‘instruct’ a device to dispense a coin(s), hold a bill in escrow, set bills accepted, etc.

Once all data has been received by the multi drop bus to personal computer interface 16 from the personal computer 30, the multi drop bus to personal computer interface 16 transmits the data over the multidrop bus 37 to the vending device. The multi-drop bus to personal computer interface 16 sets the mode bit for the address of the vending device that the data is intended for, and clears the mode bit for all other bytes sent. The last byte transmitted in this stream of data is the checksum, which was calculated by the multi-drop bus to personal computer interface firmware 14. The vending device receiving the data transmits an ACK indicating to the multi-drop bus to personal computer interface 16 that the data was received correctly as determined by the separately calculated checksums that are compared by the vending machine controller 50. If the vending machine controller 50 does not correctly receive the data (checksum error), then it sends a RET (retransmit) and the microprocessor 15 retransmits the last stream of data. Once the data has been sent from the personal computer 30 to the multi drop bus to personal computer interface 16 and it has been confirmed that it has been sent/received correctly (ACK), the microprocessor 15 begins again polling the vending devices.

The multi-drop bus to personal computer interface 16 includes two mode select jumpers. Upon cycling power or at startup, the multi-drop bus to personal computer interface 16 tests the status of these jumpers. There are three possible combinations of these jumpers. Mode select jumper one is used to select between operational mode or test mode. This is mainly used for testing the output from the vending devices. Mode select jumper two is used to introduce a delay before the multi-drop bus to personal computer interface 16 starts polling. This is necessary because some brands of bill validators require a five second delay to allow them to initialize before polling starts, otherwise the bill validators send an error to the multidrop bus to personal computer interface 16 indicating they are disabled from the vending machine controller 50.

Typically, a customer inserts a denomination of a dollar bill 41 into a bill acceptor 40, a coin or token 43 into a coin or token acceptor 42, or a credit card 45 into a credit card reader 44. The bill acceptor 40, token acceptor 42 and credit card reader 44 include processing capability, programmable logic controller, which verifies currency amount and generates electronic digital pulses to describe such currency amount.

According to FIG. 2, the generated digital pulses include a repeating series of bytes 104, 118 that includes the start bit 110, eight data bits 100, the mode bit 107 and the stop bit 108. The eight data bits of the first byte represents currency denomination along with further applicable information based on the vending system being accessed.

A vending system could include a candy dispensing device, an internet accessing device, a parking garage timing device, or many other devices. Typically, a vending system manager sits in front of the personal computer 30 and has the capability of controlling certain system functions through the use of the personal computer 30.

Presently, personal computers interface with the pliant currency acceptor using RS-232 interface, such as disclosed in U.S. Pat. No. 5,822,215 to Hoffman, which is herein incorporated by reference. New vending industry standards dictate that data be transmitted through the multi-drop bus 37.

Therefore, and in accordance with the invention, the multi-drop bus interface converts the multi-drop bus protocol to “non-standard” RS-232 protocol for input to the personal computer 30 through the RS-232 interface 17.

As previously mentioned, the data comprises a repeating succession of bytes that includes a start nit, eight data bits, mode bit and a stop bit. The data itself is not repeating, but rather the datagram (start bit, eight data bits, mode bit and stop bit) repeats.

The logical sequence of vending steps will now be described in accordance with FIG. 3. First, all currency acceptor devices are initialized 130. Next, the multi-drop bus interface processor polls each currency acceptor device seeking data 132. If data is not being transmitted, the multi-drop bus interface processor continues polling each currency acceptor device 134. If data is being transmitted from any currency acceptor device, then the multi-drop bus interface processor receives the data 136 and converts the data to RS-232 or other serial format 138. The multi-drop bus interface processor continues to poll each currency acceptor device at a rate of between 20-200 milliseconds.

The converted data is transmitted to the personal computer 30 through the use of an RS-232 or other compatible serial interface 140. Next, the personal computer 30 continues to look for data through the RS-232 or other compatible interface 142.

If the DTR is low then, the personal computer 30 stops looking for data 146. If the DTR is high, then the personal computer 30 receives and transmits data through the RS-232 or other compatible interface and through the multi-drop bus to personal computer interface 16 to the currency acceptor device in use 148 and 150. If all of the data is transmitted 152, then the multi-drop bus interface continues to poll each currency acceptor device 132. Otherwise, data will continue to be transferred between the personal computer and the currency acceptor device in use.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What we claim is:

1. A multi-drop bus vending system comprising;
At least one vending device, said vending device including means for determining input data and means for generating an output signal responsive to said input data;
A multi-drop bus for carrying said output signal, said output signal including modal information;
A personal computer responsive to said vending device output signal, and connected between said multidrop bus and said personal; and
A multidrop bus to personal computer interface circuit for transposing said output signal by managing and removing said modal information.

2. The vending system of claim 1, wherein said multidrop bus to personal computer interface circuit further includes a multidrop bus interface and a serial interface.

3. The vending system of claim 2, wherein said serial interface is selected from the group consisting essentially of an RS-232 interface, an RS-232C interface, an RS-485 interface and a universal serial bus interface.

4. The vending system of claim 2, wherein said multidrop bus to personal computer interface performs said managing and removing said modal information.

5. The vending system of claim 3, wherein said multidrop bus to personal computer interface performs said managing and removing said modal information.

6. The vending system of claim 1, wherein said personal computer includes software capable of reading, from and sending information to said at least one vending device through said multidrop bus to personal computer interface.

7. The vending system of claim 6, wherein said personal computer further includes an application programming interface for managing said at least one vending device.

8. A data flow method for a multi-drop bus vending system, said method comprising:
Inputting data into at least one multi-drop bus vending device;
Outputting a first digital signal by said at least one multi-drop bus vending device responsive to said input data, wherein said first digital signal includes modal data;
Receiving said first digital signal by a multi-drop bus to personal computer interface;
Managing said modal data by said multi-drop bus to personal computer interface;
Outputting a second output signal by said multidrop bus to personal computer interface, wherein said second output signal lacks modal data; and
inputting said second output signal into a personal computer.

9. A multi-drop bus to personal computer interface for transposing vending system data from at least one vending device off of a multidrop bus,
wherein said vending system data includes at least one start bit, a plurality of data bits, at least one modal bit and at least one stop bit, said multidrop bus to personal computer interface comprising:
means for polling said at least one vending device;
means for managing said at least one modal bit;
means for transposing said vending system data including removing said at least one modal bit; and
means for inputting said transposed data into a personal computer.
